(19) United States
(12) Patent Application Publication
(10) Pub. No.: US 2008/0240247 A1
(43) Pub. Date: Oct. 2, 2008

(54) METHOD OF ENCODING AND DECODING MOTION MODEL PARAMETERS AND VIDEO ENCODING AND DECODING METHOD AND APPARATUS USING MOTION MODEL PARAMETERS

(75) Inventors: Sangrae LEE, Suwon-si (KR); Kyo-Hyuk Lee, Yongin-si (KR); Mathew Manu, Suwon-si (KR); Tammy Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/028,846

(22) Filed: Feb. 11, 2008

(30) Foreign Application Priority Data
Mar. 29, 2007 (KR) 10-2007-0031135

(51) Int. Cl. H04N 7/12

(52) U.S. Cl. 375/240.16; 375/E07.125

(57) ABSTRACT

Provided are a method of efficiently transmitting motion model parameters using temporal correlation between video frames and a video encoding and decoding method and apparatus, in which motion estimation and motion compensation are performed by generating a plurality of reference pictures that are motion-compensated using motion model parameters. Motion model parameters are encoded based on temporal correlation between motion vectors of representative points expressing the motion model parameters, global motion compensation is performed on a previous reference video frame using motion model parameters in order to generate a plurality of transformation reference pictures, and a current video frame is encoded using the plurality of transformation reference pictures.

### CROSS-REFERENCE TO RELATED PATENT APPLICATION

This application claims priority from Korean Patent Application No. 10-2007-0031135, filed on Mar. 29, 2007, in the Korean Intellectual Property Office, the disclosure of which is incorporated herein in their entirety by reference.

### BACKGROUND OF THE INVENTION

1. Field of the Invention

Methods and apparatuses consistent with the present invention relate to video coding, and more particularly, to transmitting motion model parameters using temporal correlation between video frames, and video encoding and decoding in which motion estimation and motion compensation are performed by generating a plurality of reference pictures that are motion-compensated using motion model parameters.

2. Description of the Related Art

Motion estimation and motion compensation play a key role in video data compression and use high temporal redundancy between consecutive frames in a video sequence for high compression efficiency. Block matching is the most popular motion estimation method for removing temporal redundancy between consecutive frames. However, when an entire image is being enlarged, reduced, or rotated, motion vectors of all blocks included in the image have to be transmitted, degrading encoding efficiency. In order to solve this problem, various motion models capable of expressing a motion vector field of the entire image frame without using a number of parameters, such as an affine motion model, a translation motion model, a perspective motion model, an isotropic motion model, and a projective motion model, have been suggested.

FIG. 1 is a reference view for explaining the affine motion model.

The affine motion model is expressed by predetermined parameters (a11, a12, a21, a22, Δx, Δy) that define a transformation relationship between the original coordinates (x,y) and transformed coordinates (x′,y′) using Equation 1 as follows:

$$[ \begin{matrix}{x}^{′} \\ {y}^{′} \\ 1\end{matrix} ] = [ \begin{matrix}{a}_{11} & {a}_{12} & {Δ}_{x} \\ {a}_{21} & {a}_{22} & {Δ}_{y} \\ 0 & 0 & 1\end{matrix} ] [ \begin{matrix}x \\ y \\ 1\end{matrix} ] \qquad ( Equation 1 )$$

If the six parameters (a11, a12, a21, a22, Δx, Δy) of the affine motion model have to be transmitted for each video frame, an amount of bits to be currently encoded may increase. Referring to FIG. 1, by substituting coordinate information of four pixels (a,b,c,d) of a reference picture and coordinate information of four pixels (a′, b′, c′, d′) of the current frame corresponding to the pixels (a,b,c,d) of the reference picture into Equation 1, the six parameters (a11, a12, a21, a22, Δx, Δy) of the affine motion model can be calculated. Thus, according to the prior art, a motion vector at each representative point of a reference picture is transmitted to a decoding side, instead of separately transmitting parameters of a motion model, in order to allow the decoding side to generate the parameters of the motion model. According to the prior art, the motion vectors of the representative points are also differentially encoded based on temporal correlation between the motion vectors, thereby reducing the amount of generated bits. For example, when a motion vector of the pixel a is MV1, a motion vector of the pixel b is MV2, a motion vector of the pixel c is MV3, and a motion vector of the pixel d is MV4, the motion vector MV1 of the pixel a is encoded, a differential value between the motion vector MV2 of the pixel b and the motion vector MV1 of the pixel a is encoded for the motion vector MV2 of the pixel b, a differential value between the motion vector MV3 of the pixel c and the motion vector MV1 of the pixel a is encoded for the motion vector MV3 of the pixel c, and for the motion vector MV4 of the pixel d, a differential value between the motion vector MV4 of the pixel d and the motion vector MV1 of the pixel a, a differential value between the motion vector MV4 of the pixel d and the motion vector MV2 of the pixel b, and a differential value between the motion vector MV4 of the pixel d and the motion vector MV3 of the pixel c are encoded, and the encoded motion vector MV1 and the encoded differential values are transmitted.

However, there is still a need for an efficient video compression method in order to overcome limited bandwidth and provide high-quality video.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method of efficiently encoding motion model parameters for each of a plurality of video frames based on temporal correlation between the video frames.

The present invention also provides a video encoding method, in which a plurality of reference pictures that reflect motion information of regions included in a current video frame are generated using a plurality of motion model parameters extracted from the current video frame and a previous video frame and the current video frame is encoded using the plurality of reference pictures, thereby improving video compression efficiency.

The present invention also provides a video encoding method, in which the amount of generated bits can be reduced by efficiently assigning a reference index during the generation of a reference picture list.

According to one aspect of the present invention, there is provided a method of encoding motion model parameters describing global motion of each video frame of a video sequence. The method includes selecting a plurality of representative points for determining the motion model parameters in each of a plurality of video frames and generating motion vectors of the representative points of each video frame, calculating differential motion vectors corresponding to differential values between motion vectors of representative points of a previous video frame and motion vectors of representative points of a current video frame, which correspond to the representative points of the previous video frame, and encoding the differential motion vectors as motion model parameter information of the current video frame.

According to another aspect of the present invention, there is provided a method of decoding motion model parameters describing global motion of each of a plurality of video frames of a video sequence. The method includes extracting differential motion vectors corresponding to differential values between motion vectors of representative points of a previously decoded video frame, i.e., a previous video frame, and motion vectors of representative points of a current video frame from a received bitstream, adding the extracted differential motion vectors to the motion vectors of the representative points of the previous video frame in order to reconstruct the motion vectors of the representative points of the current video frame, and generating the motion model parameters using the reconstructed motion vectors of the representative points of the current video frame.

According to another aspect of the present invention, there is provided a video encoding method using motion model parameters. The video encoding method includes comparing a current video frame with a previous video frame in order to extract a plurality of motion model parameters, performing global motion compensation on the previous video frame using the extracted motion model parameters in order to generate a plurality of transformation reference pictures, performing motion estimation/compensation on each of a plurality of blocks of the current video frame using the transformation reference pictures in order to determine a transformation reference picture to be referred to by each block of the current video frame, and assigning a small reference index to a transformation reference picture that is referred to a large number of times by each block included in each predetermined coding unit that group blocks of the current video frame in order to generate a reference picture list.

According to another aspect of the present invention, there is provided a video encoding apparatus using motion model parameters. The video encoding apparatus includes a motion model parameter generation unit comparing a current video frame with a previous video frame in order to extract a plurality of motion model parameters, a multiple reference picture generation unit performing global motion compensation on the previous video frame using the extracted motion model parameters in order to generate a plurality of transformation reference pictures, a motion estimation/compensation unit performing motion estimation and compensation on each of a plurality of blocks of the current video frame using the transformation reference pictures in order to determine a transformation reference picture to be referred to by each block of the current video frame, and a reference picture information generation unit assigning a small reference index to a transformation reference picture that is referred to a large number of times by each block included in each of a plurality of predetermined coding units generated by grouping blocks of the current video frame in order to generate a reference picture list.

According to another aspect of the present invention, there is provided a video decoding method using motion model parameters. The video decoding method includes performing global motion compensation on a previous video frame that precedes a current video frame to be currently decoded, using motion model parameter information extracted from a received bitstream in order to generate a plurality of transformation reference pictures, extracting a reference index of a transformation reference picture referred to by each of a plurality of blocks of the current video frame from a reference picture list included in the bitstream, performing motion compensation on each block of the current video frame using the transformation reference picture indicated by the extracted reference index in order to generate a prediction block, and adding the prediction block to a residue included in the bitstream in order to reconstruct the current block.

According to another aspect of the present invention, there is provided a video decoding apparatus using motion model parameters. The video decoding apparatus includes a multiple reference picture generation unit performing global motion compensation on a previous video frame that precedes a current video frame to be currently decoded, using motion model parameter information extracted from a received bitstream in order to generate a plurality of transformation reference pictures, a reference picture determination unit extracting a reference index of a transformation reference picture referred to by each of a plurality of blocks of the current video frame from a reference picture list included in the bitstream, a motion compensation unit performing motion compensation on each block of the current video frame using the transformation reference picture indicated by the extracted reference index in order to generate a prediction block, and an addition unit adding the prediction block to a residue included in the bitstream in order to reconstruct the current block.

### BRIEF DESCRIPTION OF THE DRAWINGS

The above and other aspects of the present invention will become more apparent by describing in detail exemplary embodiments thereof with reference to the attached drawings in which:

FIG. 1 is a reference view for explaining an affine motion model;

FIG. 2 is a flowchart illustrating a method of encoding motion model parameters describing global motion of each of a plurality of video frames of a video sequence, according to an exemplary embodiment of the present invention;

FIG. 3 is a reference view for explaining a method of encoding motion model parameters, according to an exemplary embodiment of the present invention;

FIG. 4 is a flowchart illustrating a method of decoding motion model parameters, according to an exemplary embodiment of the present invention;

FIG. 5 is a block diagram of a video encoding apparatus using motion model parameters, according to an exemplary embodiment of the present invention;

FIG. 6 is a view for explaining a process in which a motion model parameter generation unit illustrated in FIG. 5 extracts motion model parameter information, according to an exemplary embodiment of the present invention;

FIG. 7 illustrates transformation reference pictures that are generated by performing motion compensation on a previous video frame illustrated in FIG. 6 using motion model parameters detected from the previous video frame and a current video frame, according to an exemplary embodiment of the present invention;

FIG. 8 is a view for explaining a method of generating a reference picture list, according to an exemplary embodiment of the present invention;

FIG. 9 is a view for explaining a method of predicting a reference index of a current block using a reference index of a neighboring block, according to an exemplary embodiment of the present invention;

FIG. 10 is a flowchart of a video encoding method using motion model parameters, according to an exemplary embodiment of the present invention;

FIG. 11 is a block diagram of a video decoding apparatus according to an exemplary embodiment of the present invention; and

FIG. 12 is a flowchart of a video decoding method according to an exemplary embodiment of the present invention.

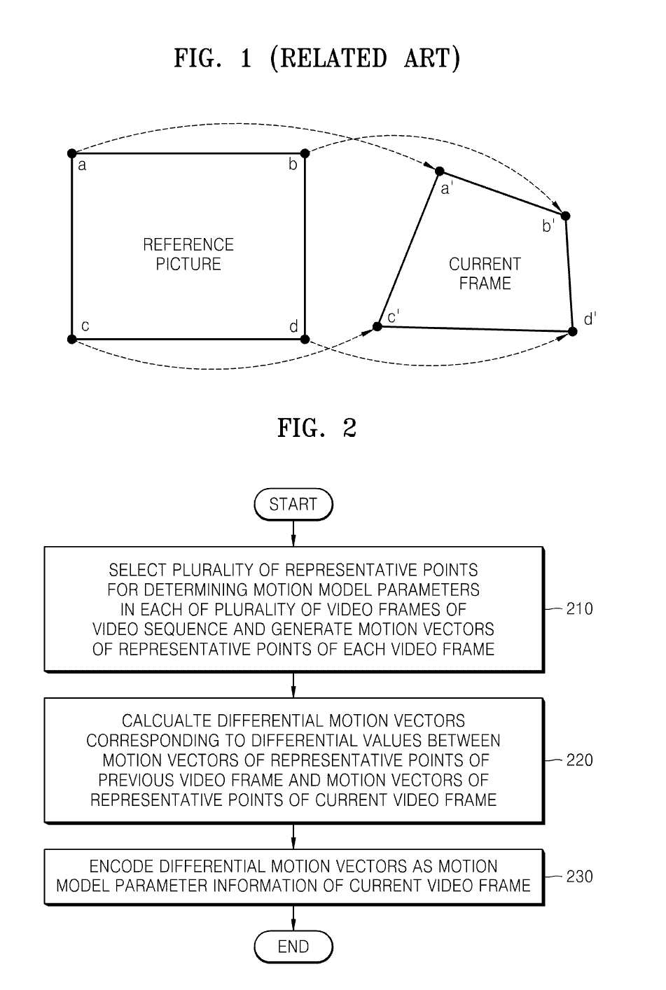

### DETAILED DESCRIPTION OF EXEMPLARY EMBODIMENTS OF THE INVENTION

Hereinafter, exemplary embodiments of the present invention will be described in detail with reference to the accompanying drawings. It should be noticed that like reference numerals refer to like elements illustrated in one or more of the drawings. In the following description of the present invention, detailed descriptions of known functions and configurations incorporated herein will be omitted for conciseness and clarity.

FIG. 2 is a flowchart illustrating a method of encoding motion model parameters describing global motion of each of a plurality of video frames of a video sequence, according to an exemplary embodiment of the present invention.

The method of encoding the motion model parameters according to the current exemplary embodiment of the present invention efficiently encodes motion vectors of representative points used for the generation of the motion model parameters based on temporal correlation between video frames. Although an affine motion model among various motion models will be used as an example in the following description of exemplary embodiments, embodiments the present invention can also be applied to other motion models such as a translation motion model, a perspective motion model, an isotropic motion model, and a projective motion model.

Referring to FIG. 2, in operation 210, a plurality of representative points for determining motion model parameters are selected in each of a plurality of video frames of a video sequence and motion vectors indicating motions at the representative points in each video frame are generated.

In operation 220, differential motion vectors corresponding to differential values between motion vectors of representative points of a previous video frame and motion vectors of representative points of a current video frame, which correspond to the representative points of the previous video frame, are calculated.

In operation 230, the differential motion vectors are encoded as motion model parameter information of the current video frame.

In the method of encoding the motion model parameters according to the current exemplary embodiment of the present invention, the motion vectors of the representative points of the current video frame are predicted from the motion vectors of the corresponding representative points of the previous video frame based on a fact that predetermined correlation exists between motion vectors of representative points of temporally adjacent video frames, and then only differential values between the predicted motion vectors and the true motion vectors of the representative points of the current video frame are encoded.

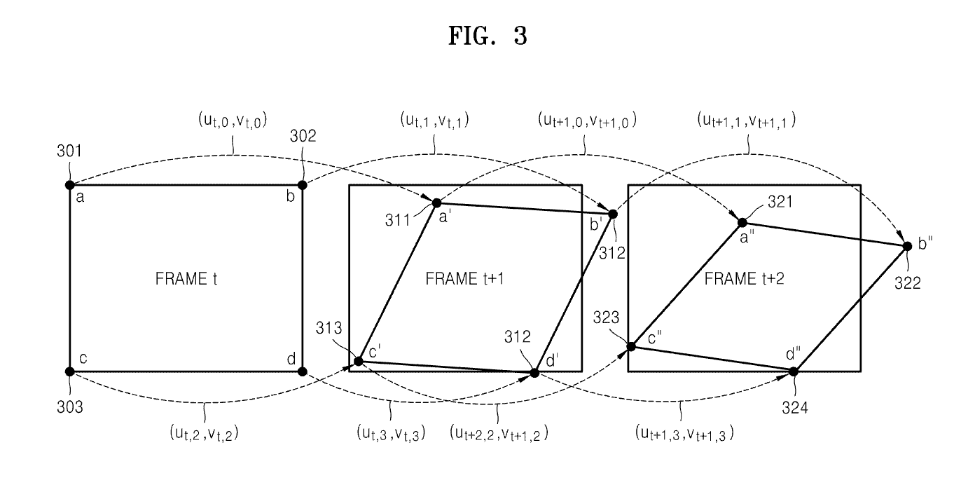

FIG. 3 is a reference view for explaining a method of encoding motion model parameters, according to an exemplary embodiment of the present invention. In FIG. 3, video frames at times t, (t+1), and (t+2) in a video sequence are illustrated. Reference characters a, a′, and a″ indicate first representative points of the video frame at t, the video frame at (t+1), and the video frame at (t+2), which correspond to one another, reference characters b, b′, and b″ indicate second representative points of the video frame at t, the video frame at (t+1), and the video frame at (t+2), which correspond to one another, reference characters c, c′, and c″ indicate third representative points of the video frame at t, the video frame at (t+1), and the video frame at (t+2), which correspond to one another, and reference characters d, d′, and d″ indicate fourth representative points of the video frame at t, the video frame at (t+1), and the video frame at (t+2), which correspond to one another.

Referring to FIG. 3, (Ux,y, Vx,y) indicates a motion vector of an (y+1)th representative point in a video frame at time x, in which x=t, t+1, t+2 and y=0,1,2,3, and (Ux,y, Vx,y) is calculated using the spatial position change of the (y+1)th representative point in the video frame at time x and an (y+1)th representative point in the video frame at time (x+1). For example, (Ut,0, Vt,0) is a motion vector corresponding to a position difference between the first representative point a in the video frame at time t and the first representative point a′ in the video frame at time (t+1).

According to an exemplary embodiment of the present invention, differential motion vectors corresponding to differential values between motion vectors of representative points of a previous video frame and motion vectors of representative points of a current video frame, which correspond to the representative points of the previous video frame, are calculated and are transmitted as motion model parameter information, in which the previous video frame and the current video frame are temporally adjacent to each other. In other words, referring to FIG. 3, a differential value (Ut+1,0−Ut,0, Vt+1,−Vt,0) between the motion vector (Ut,0, Vt,0) of the first representative point a in the video frame at time t and the motion vector (Ut+1,0, Vt+1,0) of the first representative point a′ in the video frame at time (t+1) is transmitted as motion vector information of the first representative point a′ in the video frame at time (t+1). A decoding apparatus then predicts the motion vector (Ut,0, Vt,0) of the first representative point a in the previous video frame at time t as a prediction motion vector of the first representative point a′ in the current video frame at time (t+1) and adds the differential value to the prediction motion vector, thereby reconstructing the motion vector (Ut+1,0, Vt+1,0) of the first representative point a′ of the current video frame at time (t+1). Similarly, when a differential value (Ut+1,1−Ut,1, Vt+1,1−Vt,1) between a motion vector (Ut,1, Vt,1) of the second representative point b in the previous video frame at time t and a motion vector (Ut+1,1, Vt+1,1) of the second representative point b′ in the current video frame at time (t+1) is encoded and transmitted as information about the motion vector (Ut,1, Vt,1) of the second representative point b′ in the current video frame at time (t+1), the decoding apparatus predicts the motion vector (Ut,1, Vt,1) of the second representative point b in the previous video frame at time t as a prediction motion vector of the second representative point b′ in the current video frame at time (t+1) and adds the differential value to the prediction motion vector, thereby reconstructing the motion vector (Ut+1,1, Vt+1,1) of the second representative point b′ in the current video frame at time (t+1).

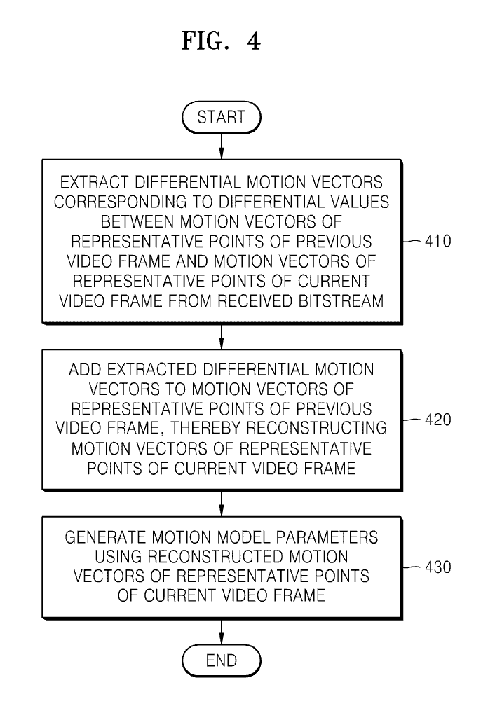

FIG. 4 is a flowchart illustrating a method of decoding motion model parameters, according to an exemplary embodiment of the present invention.

Referring to FIG. 4, in operation 410, differential motion vectors corresponding to differential values between motion vectors of representative points of a previous video frame and motion vectors of representative points of a current video frame are extracted from a received bitstream.

In operation 420, the extracted differential motion vectors are added to the motion vectors of the representative points of the previous video frame, thereby reconstructing the motion vectors of the representative points of the current video frame.

In operation 430, motion model parameters are generated using the reconstructed motion vectors of the representative points of the current video frame. For example, when the affine motion model expressed by Equation 1 is used, six motion model parameters constituting the affine motion model can be determined by substituting the reconstructed motion vectors of the representative points of the current video frame into Equation 1.

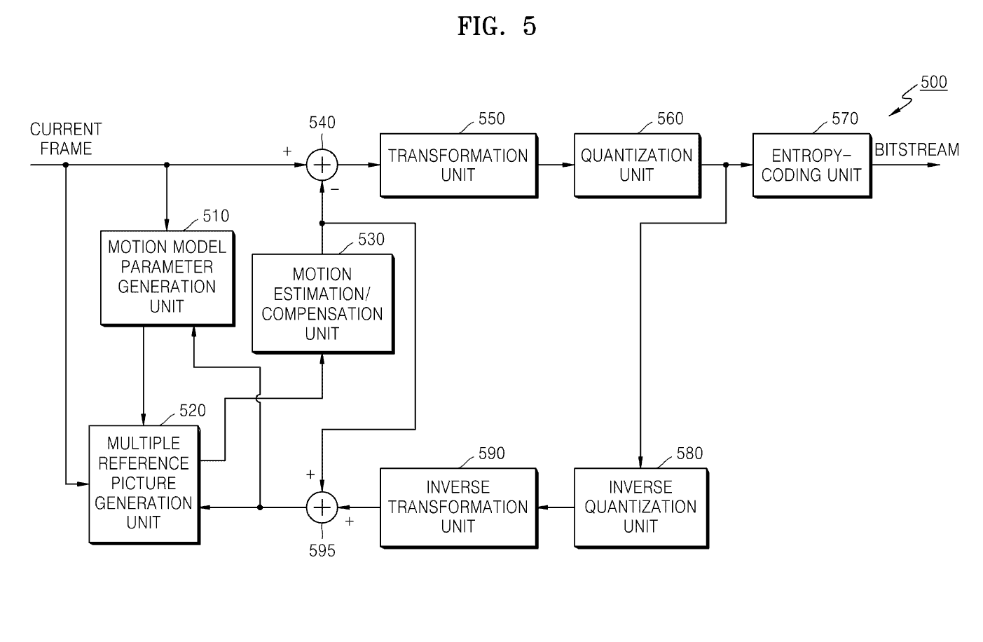

FIG. 5 is a block diagram of a video encoding apparatus 500 using motion model parameters, according to an exemplary embodiment of the present invention.

The video encoding apparatus 500 according to the current exemplary embodiment of the present invention compares a current video frame with a previous video frame in order to extract a plurality of motion model parameters, performs global motion compensation on the previous video frame using the extracted motion model parameters in order to generate a plurality of transformation reference pictures, and performs predictive-encoding on the current video frame using the generated transformation reference pictures.

Referring to FIG. 5, the video encoding apparatus 500 according to the current exemplary embodiment of the present invention includes a motion model parameter generation unit 510, a multiple reference picture generation unit 520, a motion estimation/compensation unit 530, a subtraction unit 540, a transformation unit 550, a quantization unit 560, an entropy-coding unit 570, an inverse quantization unit 580, an inverse transformation unit 590, and an addition unit 595.

The motion model parameter generation unit 510 compares the current video frame to be currently encoded with a previous video frame in order to extract a plurality of motion model parameters for matching each region or object in the current video frame with each region or object in the previous video frame.

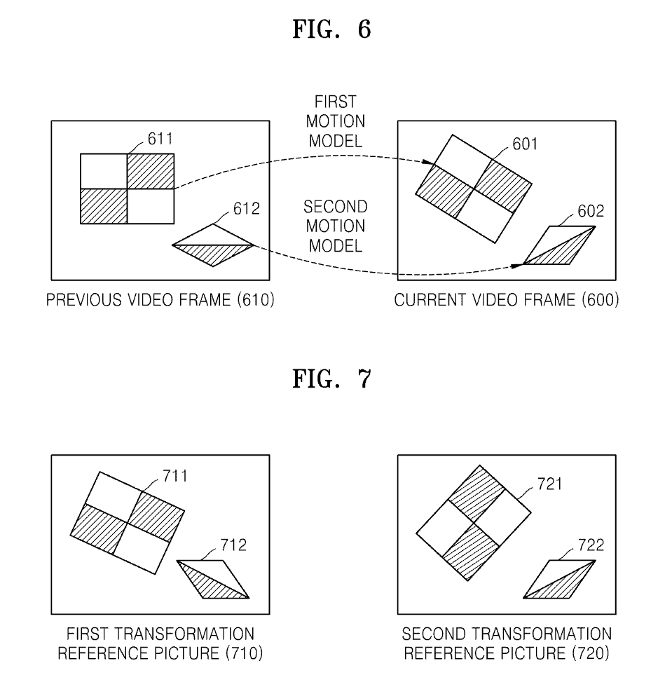

FIG. 6 is a view for explaining a process in which the motion model parameter generation unit 510 illustrated in FIG. 5 extracts the motion model parameters, according to an exemplary embodiment of the present invention.

Referring to FIG. 6, the motion model parameter generation unit 510 compares a current video frame 600 with a previous video frame 610 in order to detect a video region corresponding to a difference between the current video frame 600 and the previous video frame 610, detects motion of the detected video region, and generates motion model parameters by applying the affine motion model to feature points of the detected video region. For example, the motion model parameter generation unit 510 may distinguish a video region that differs from the previous video frame 610 by calculating a differential value between the previous video frame 610 and the current video frame 600 and thus may determine a video region corresponding to a differential value that is greater than a predetermined threshold, or may distinguish first and second objects 611 and 612 in the previous video frame 610 using various well-known object detection algorithms and detect motion changes of the detected first and second objects 611 and 612 in the current video frame 600 in order to generate motion model parameters indicating the detected motion changes. In other words, the motion model parameter generation unit 510 detects a first motion model parameter indicating motion information of the first object 611 in the previous video frame 610 between the current video frame 600 and the previous video frame 610 and a second motion model parameter indicating motion information of the second object 612 in the previous video frame 610 between the current video frame 600 and the previous video frame 610. In FIG. 6, the first motion model parameter indicates clockwise predetermined-angle rotation from the previous video frame 610 and the second motion model parameter indicates counterclockwise predetermined-angle rotation from the previous video frame 610. The first motion model parameter and the second motion model parameter can be calculated by substituting coordinates of a pixel of the previous video frame 610 and coordinates of a corresponding pixel of the current video frame 600 into Equation 1.

Referring back to FIG. 5, the multiple reference picture generation unit 520 generates a plurality of transformation reference pictures by performing global motion compensation on the previous video frame using the extracted motion model parameters.

FIG. 7 illustrates transformation reference pictures that are generated by performing motion compensation on the previous video frame 610 illustrated in FIG. 6 using motion model parameters detected from the previous video frame 610 and the current video frame 600, according to an exemplary embodiment of the present invention.

As mentioned above, the first motion model parameter and the second motion model parameter detected from the previous video frame 610 and the current video frame 600 are assumed to indicate clockwise rotation and counterclockwise rotation, respectively. In this case, the multiple reference picture generation unit 520 performs global motion compensation by applying each of the first motion model parameter and the second motion model parameter to the previous video frame 610. In other words, the multiple reference picture generation unit 520 performs global motion compensation on each pixel of the previous video frame 610 using the first motion model parameter in order to generate a first transformation reference picture 710 and performs global motion compensation on each pixel of the previous video frame 610 using the second motion model parameter in order to generate a second transformation reference picture 720. When the motion model parameter generation unit 510 generates n motion model parameters, n being a positive integer, the multiple reference picture generation unit 520 may perform motion compensation on the previous video frame 610 using each of the n motion model parameters, thereby generating n transformation reference pictures.

Referring back to FIG. 5, the motion estimation/compensation unit 530 performs motion estimation/compensation on each block of the current video frame using the transformation reference pictures in order to generate a prediction block, and determines a transformation reference picture to be referred to by each block. Referring to FIGS. 6 and 7, the motion estimation/compensation unit 530 determines the first transformation reference picture 710 for encoding a block region corresponding to a first object 601 of the current video frame 600 and determines the second transformation reference frame 720 for encoding a block region corresponding to a second object 602 of the current video frame 600.

Once the motion estimation/compensation unit 530 generates a prediction block of the current block using the transformation reference pictures, the subtraction unit 540 calculates a residual corresponding to a difference between the current block and the prediction block. The transformation unit 550 and the quantization unit 560 perform discrete cosine transformation (DCT) and quantization on the residual. The entropy-coding unit 570 performs entropy-coding on quantized transformation coefficients, thereby performing compression.

In a video encoding method according to an exemplary embodiment of the present invention, it is necessary to transmit information about which one of the plurality of transformation reference pictures has been used for predicting each block in the current video frame. For the reference picture information, a reference picture information generation unit (not shown) included in the entropy-coding unit 570 may calculate the number of references to a transformation reference picture referred to each block included in each predetermined coding unit generated by grouping blocks of the current video frame, e.g., each slice, may assign a small reference index RefIdx to a transformation reference picture that is referred to by the blocks included in the slice a number of times in order to generate a reference picture list, and may insert the reference picture list to a bitstream to be transmitted.

When a small reference index is assigned to a transformation reference picture that is referred to a number of times by blocks in a slice, information about the reference index, i.e., reference index information, is transmitted in the form of a differential value between the reference index of a currently encoded block and a reference index of a previously encoded block, thereby reducing the amount of bits required for expressing the reference picture information.

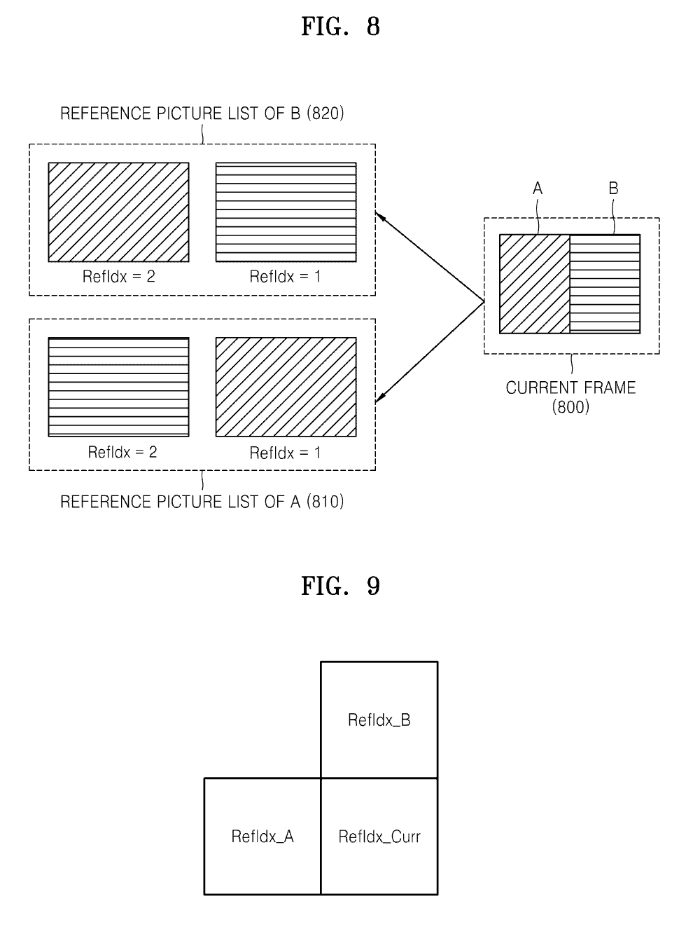

FIG. 8 is a view for explaining a method of generating a reference picture list, according to an exemplary embodiment of the present invention. In FIG. 8, it is assumed that a current frame 800 includes a second video portion B and a first video portion B inclined at an angle of 45° with respect to the second video portion B.

Referring to FIG. 8, in order to generate a reference picture list 810 for blocks included in the first video portion A, the reference picture information generation unit assigns a first reference index to a transformation reference picture that is transformed in a similar motion direction to that of the first video portion A. In order to generate a reference picture list 820 for blocks included in the second video portion B, the reference picture information generation unit assigns the first reference index to a transformation reference picture that is transformed in a similar motion direction to that of the second video portion B.

When the reference picture information generation unit generates a reference index for each block, it may generate a prediction reference index based on correlation with a reference index of a neighboring block and transmit only a differential value between the true reference index and the prediction reference index, thereby reducing the amount of reference index information.

FIG. 9 is a view for explaining a method of predicting a reference index of a current block using a reference index of a neighboring block, according to an exemplary embodiment of the present invention. Referring to FIG. 9, a prediction reference index RefIdx_Pred for a reference index RefIdx_Curr of the current block is predicted to be a minimum value between a reference index RefIdx_A of a neighboring block located to the left of the current block and a reference index RefIdx_B of a neighboring block located above the current block. In other words, (RefIdx_Pred)=Min(RefIdx_A, RefIdx_B). When the reference picture information generation unit transmits a differential value between the reference index RefIdx_Curr of the current block and the prediction reference index RefIdx_Pred, a decoding apparatus generates a prediction reference index using the same process as in an encoding apparatus and adds the prediction reference index to a reference index differential value included in the bitstream, thereby reconstructing the reference index of the current block.

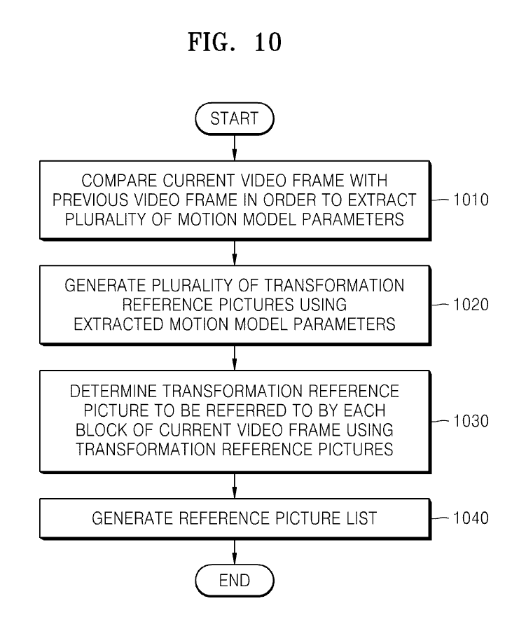

FIG. 10 is a flowchart of a video encoding method using motion model parameters, according to an exemplary embodiment of the present invention.

Referring to FIG. 10, in operation 1010, a current video frame and a previous video frame are compared with each other in order to extract a plurality of motion model parameters.

In operation 1020, global motion compensation is performed on the previous video frame using the extracted motion model parameters, thereby generating a plurality of transformation reference pictures.

In operation 1030, motion estimation/compensation is performed on each of a plurality of blocks of the current video frame using the transformation reference pictures, thereby determining a transformation reference picture to be referred to by each block of the current video frame.

In operation 1040, a small reference index is assigned to a transformation reference picture that is referred to by blocks included in each predetermined coding unit, e.g., each slice, a number of times, in order to generate a reference picture list, and the generated reference picture list is entropy-coded and transmitted to a decoding apparatus. As mentioned above, a reference index of each block may be encoded and transmitted in the form of a differential value between the reference index and a prediction reference index that is predicted using a reference index of a neighboring block.

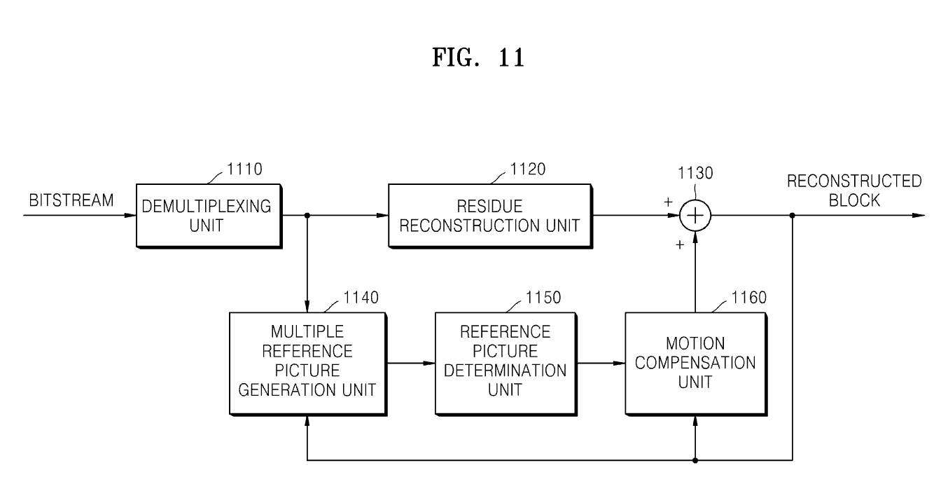

FIG. 11 is a block diagram of a video decoding apparatus according to an exemplary embodiment of the present invention.

Referring to FIG. 11, the video decoding apparatus according to the current exemplary embodiment of the present invention includes a demultiplexing unit 1110, a residue reconstruction unit 1120, an addition unit 1130, a multiple reference picture generation unit 1140, a reference picture determination unit 1150, and a motion compensation unit 1160.

The demultiplexing unit 1110 extracts various prediction mode information used for encoding a current block, e.g., motion model parameter information, reference picture list information, and residue information of texture data according to the present invention, from a received bitstream, and outputs the extracted information to the multiple reference picture generation unit 1140 and the residue reconstruction unit 1120.

The residue reconstruction unit 1120 performs entropy-decoding, inverse quantization, and inverse transformation on residual data corresponding to a difference between a prediction block and the current block, thereby reconstructing the residual data.

The multiple reference picture generation unit 1140 performs global motion compensation on a previous video frame that precedes a current video frame to be currently decoded, using the motion model parameter information extracted from the received bitstream, thereby generating a plurality of transformation reference pictures.

The reference picture determination unit 1150 determines a reference index of a transformation reference picture referred to by each block of the current video frame from a reference picture list. As mentioned above, when a reference index of the current block has been encoded in the form of a differential value between the reference index and a prediction reference index predicted using a reference index of a neighboring block of the current block, the reference picture determination unit 1150 first determines the prediction reference index using the reference index of the neighbor block and then adds a reference index differential value included in the bitstream to the prediction reference index, thereby reconstructing the reference index of the current block.

The motion compensation unit 1160 performs motion compensation on each block of the current video frame using a transformation reference picture indicated by the reconstructed reference index, thereby generating a prediction block of the current block.

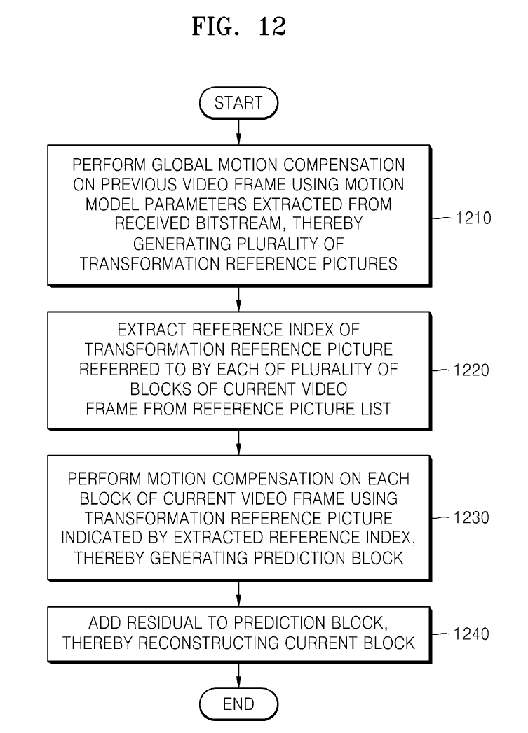

FIG. 12 is a flowchart of a video decoding method according to an exemplary embodiment of the present invention.

Referring to FIG. 12, in operation 1210, global motion compensation is performed on a previous video frame that precedes a current video frame to be currently decoded, using motion model parameter information that is extracted from a received bitstream, thereby generating a plurality of transformation reference pictures.

In operation 1220, a reference index of a transformation reference picture referred to by each block of the current video frame is extracted from a reference picture list.

In operation 1230, motion compensation is performed on each of a plurality of blocks of the current video frame using a transformation reference picture indicated by the extracted reference index, thereby generating a prediction block of the current block.

In operation 1240, the generated prediction block is added to a residual included in the bitstream, thereby reconstructing the current block.

The present invention can be embodied as a computer-readable code on a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, and optical data storage devices. The computer-readable recording medium can also be distributed over network of coupled computer systems so that the computer-readable code is stored and executed in a decentralized fashion.

As described above, according to the exemplary embodiments of the present invention, motion model parameters are predictive-encoded based on temporal correlation between video frames, thereby reducing the amount of transmission bits of the motion model parameters.

Moreover, according to the exemplary embodiments of the present invention, reference pictures reflecting various motions in a current video frame are generated using motion model parameters and video encoding is performed using the reference pictures, thereby improving video encoding efficiency.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of encoding motion model parameters describing global motion of each of a plurality of video frames of a video sequence, the method comprising:
selecting a plurality of representative points for determining the motion model parameters in each of the plurality of video frames and generating motion vectors of the representative points of each of the plurality of video frames;
calculating differential motion vectors corresponding to differential values between motion vectors of representative points of a previous video frame and motion vectors of representative points of a current video frame, which correspond to the representative points of the previous video frame; and
encoding the differential motion vectors as motion model parameter information of the current video frame.

2. The method of claim 1, wherein the motion model parameters are parameters of one of an affine motion model, a translation motion model, a perspective motion model, an isotropic motion model, and a projective motion model.

3. The method of claim 1, wherein the generating the motion vectors of the representative points comprises calculating motion vectors that start from the representative points of each of the plurality of video frames and end at pixels of a reference frame, which correspond to the representative points.

4. A method of decoding motion model parameters describing global motion of each of a plurality of video frames of a video sequence, the method comprising:
extracting differential motion vectors corresponding to differential values between motion vectors of representative points of a previous video frame, and motion vectors of representative points of a current video frame from a received bitstream;
reconstructing the motion vectors of the representative points of the current video frame by adding the extracted differential motion vectors to the motion vectors of the representative points of the previous video frame; and
generating the motion model parameters using the reconstructed motion vectors of the representative points of the current video frame.

5. The method of claim 4, wherein the motion model parameters are parameters of one of an affine motion model, a translation motion model, a perspective motion model, an isotropic motion model, and a projective motion model.

6. A video encoding method using motion model parameters, the video encoding method comprising:
extracting a plurality of motion model parameters by comparing a current video frame with a previous video frame;
generate a plurality of transformation reference pictures by performing global motion compensation on the previous video frame using the extracted motion model parameters;
performing motion estimation and compensation on each of a plurality of blocks of the current video frame using the transformation reference pictures to thereby determine a transformation reference picture to be referred to by each of the plurality of blocks of the current video frame; and
generating a reference picture list by assigning a small reference index to a transformation reference picture that is referred to a number of times by each block included in each of a plurality of predetermined coding units that group blocks of the current video frame.

7. The video encoding method of claim 6, wherein the motion model parameters are parameters of one of an affine motion model, a translation motion model, a perspective motion model, an isotropic motion model, and a projective motion model.

8. The video encoding method of claim 6, further comprising determining a reference index of a transformation reference picture to be referred to by each block included in each of the plurality of predetermined coding units from the reference picture list and encoding reference picture information for each block using the determined reference index.

9. The video encoding method of claim 8, further comprising predicting a reference index of a current block to be currently encoded among blocks included in each of the plurality of predetermined coding units using reference indices of neighboring blocks of the current block.

10. The video encoding method of claim 9, wherein the neighboring blocks comprise a block located above and a block located to the left of the current block, and a minimum value between the reference indices of the neighboring blocks is predicted to be the reference index of the current block.

11. The video encoding method of claim 9, further comprising encoding a differential value between the reference index of the current block and the predicted reference index.

12. A video encoding apparatus using motion model parameters, the video encoding apparatus comprising:
a motion model parameter generation unit which compares a current video frame with a previous video frame to extract a plurality of motion model parameters;
a multiple reference picture generation unit which generates a plurality of transformation reference pictures by performing global motion compensation on the previous video frame using the extracted motion model parameters;
a motion estimation and compensation unit which performs motion estimation and compensation on each of a plurality of blocks of the current video frame using the transformation reference pictures, to determine a transformation reference picture to be referred to by each of the plurality of blocks of the current video frame; and
a reference picture information generation unit which generates a reference picture list by assigning a small reference index to a transformation reference picture that is referred to a number of times by each block included in each of a plurality of predetermined coding units generated by grouping blocks of the current video frame.

13. The video encoding apparatus of claim 12, wherein the motion model parameters are parameters of one of an affine motion model, a translation motion model, a perspective motion model, an isotropic motion model, and a projective motion model.

14. The video encoding apparatus of claim 12, wherein the reference picture information generation unit determines a reference index of a transformation reference picture to be referred to by each block included in each of the plurality of predetermined coding units from the reference picture list and encodes reference picture information for each block using the determined reference index.

15. The video encoding apparatus of claim 12, wherein the reference picture information generation unit predicts a reference index of a current block to be currently encoded among blocks included in each of the plurality of predetermined coding units using reference indices of neighboring blocks of the current block.

16. The video encoding apparatus of claim 15, wherein the neighboring blocks comprise a block located above and a block located to the left of the current block, and a minimum value between the reference indices of the neighboring blocks is predicted to be the reference index of the current block.

17. The video encoding apparatus of claim 15, wherein the reference picture information generation unit encodes a differential value between the reference index of the current block and the predicted reference index.

18. A video decoding method using motion model parameters, the video decoding method comprising:
generating a plurality of transformation reference pictures by performing global motion compensation on a previous video frame that precedes a current video frame to be currently decoded, using motion model parameter information extracted from a received bitstream;
extracting a reference index of a transformation reference picture referred to by each of a plurality of blocks of the current video frame from a reference picture list included in the bitstream;
generating a prediction block by performing motion compensation on each of the plurality of blocks of the current video frame using the transformation reference picture indicated by the extracted reference index; and
reconstructing the current block by adding the prediction block to a residue included in the bitstream in order.

19. The video decoding method of claim 18, wherein the extracting the reference index comprises predicting a reference index of the current block to be currently decoded among blocks included in the current video frame, using reference indices of neighboring blocks of the current block.

20. The video decoding method of claim 19, wherein the neighboring blocks comprise a block located above and a block located to the left of the current block, and a minimum value between the reference indices of the neighboring blocks is predicted to be the reference index of the current block.

21. The video decoding method of claim 18, wherein the extracting the reference index comprises adding a differential value between the reference index of the current block and a prediction reference index, which is included in the bitstream, to the predicted reference index of the current block, to reconstruct the reference index of the current block.

22. A video decoding apparatus using motion model parameters, the video decoding apparatus comprising:
a multiple reference picture generation unit which generates a plurality of transformation reference pictures by performing global motion compensation on a previous video frame that precedes a current video frame to be currently decoded, using motion model parameter information extracted from a received bitstream;
a reference picture determination unit which extracts a reference index of a transformation reference picture referred to by each of a plurality of blocks of the current video frame from a reference picture list included in the bitstream;
a motion compensation unit which performs motion compensation on each of the plurality of blocks of the current video frame using the transformation reference picture indicated by the extracted reference index, to generate a prediction block; and
an addition unit which adds the prediction block to a residue included in the bitstream to reconstruct the current block.

23. The video decoding apparatus of claim 22, wherein the reference picture determination unit predicts a reference index of the current block to be currently decoded among blocks included in the current video frame, using reference indices of neighboring blocks of the current block.

24. The video decoding apparatus of claim 23, wherein the neighboring blocks comprise a block located above and a block located to the left of the current block, and a minimum value between the reference indices of the neighboring blocks is predicted to be the reference index of the current block.

25. The video decoding apparatus of claim 22, wherein the reference picture determination unit adds a differential value between the reference index of the current block and a prediction reference index, which is included in the bitstream, to the predicted reference index of the current block, to reconstruct the reference index of the current block.
